(19) United States
(12) Patent Application Publication
(10) Pub. No.: US 2008/0089401 A1
(43) Pub. Date: Apr. 17, 2008

(54) Signal Testing System

(76) Inventors: Pao-Jen Lai, Dallas, TX (US); Khurram Waheed, Plano, TX (US); Oren Eliezer, Plano, TX (US); Gunvant T. Patel, Dallas, TX (US); Oscar Barraza, Coppell, TX (US)

Correspondence Address: TEXAS INSTRUMENTS INCORPORATED, P O BOX 655474, M/S 3999, DALLAS, TX, 75265, US

(21) Appl. No.: 11/860,935

(22) Filed: Sep. 25, 2007

Related U.S. Application Data
(60) Provisional application No. 60/829,605, filed on Oct. 16, 2006.

(51) Int. Cl. H04B 3/46

(52) U.S. Cl. 375/226

(57) ABSTRACT

One embodiment of the invention includes a method for testing the performance of a Global System for Mobile Communications (GSM) transmitter. The output of the GSM transmitter is converted to a digital signal. A power spectrum is estimated for the GSM transmitter according to the digital signal via a modified periodogram algorithm. A phase trajectory of the digital signal is determined, and an ideal phase signal is determined from the determined phase trajectory. A phase trajectory error is calculated from the determined phase trajectory and the determined ideal phase signal. A tested device may be considered compliant if the abovementioned phase error and spectral mask meet specific defined criteria, and fails the test if either of these does not meet the predefined limits. The present invention is targeted at reducing the test time and test equipment traditionally associated with the implementation of these tests.

### RELATED APPLICATION

This application claims the benefit of U.S. Provisional Patent Application No. 60/829,605, which was filed on Oct. 16, 2006, and entitled “Low Cost Testing of Phase Trajectory Error and Close-in Modulated Spectrum for a Quadruple Band GSM RFCMOS Transmitter,” the entire contents of which are incorporated herein by reference.

### TECHNICAL FIELD

This invention relates to electronic circuits, and more specifically to a signal testing system.

### BACKGROUND

A number of wireless communication systems are known in the art for modulating digital data onto a carrier signal and transmitting the resulting analog signal from a wireless transceiver. As part of the modulation, the transmission or signal obtains a particular spectral mask or characteristic response. Since the amount of available bandwidth is limited by practical conditions, it is necessary to limit the bandwidth used by given system to a narrow channel. To minimize interference between channels, the spectral mask of the transmissions must maintain spectral emissions, such as spurious emissions, below a certain level. Governmental bodies often regulate the frequency spectra available and the use of the frequencies by wireless communication system operators. These regulations may also restrict a transmission's emissions of the spectral mask at a given frequency or channel. Accordingly, it is necessary to ensure that transmitters operate at sufficient power to produce a high fidelity signal while maintaining the signal power within the prescribed bands.

As the complexity of RF transmitters has increased, it has become increasingly expensive and time consuming to evaluate the transmitter performance. For example, recent RF transceivers have been designed as integrated systems on a chip (SOC), with various digital information processing modules implemented on a single integrated circuit. In general, the digital IP cores come with some form of built-in self-test (BIST) features that can be used to test the digital cores on a structural level. Unfortunately, interoperability among the different cores can not easily be tested by these self-test features, requiring some form of functional testing to ensure compliance with limitations on the spectral mask. In general, this has required the use of an RF tester with a built-in spectral analyzer or vector spectral analyzer. Such devices are both costly to obtain and maintain and time consuming to utilize, reducing the testing throughput during production of the SOCs.

### SUMMARY

One embodiment of the present invention includes a method for testing the performance of a Global System for Mobile Communications (GSM) transmitter. The output of the GSM transmitter is converted to a digital signal. The power spectrum is estimated for the GSM transmitter by digital processing of the digitized signal using an averaged modified periodogram algorithm. A phase trajectory of the digital signal is determined, and an ideal phase signal is determined from the determined phase trajectory. A phase trajectory error is calculated from the determined phase trajectory and the determined ideal phase signal. The phase error trajectory can be processed to determine the compliance of the phase error with the defined limits such that the transmitter can be failed or passed accordingly.

Another embodiment of the present invention includes a system for testing the performance of a Global System for Mobile Communications (GSM) transmitter. A receiver apparatus down-converts the output signal of the GSM transmitter and converts it to a plurality of digital samples representing a digital signal. An averaged modified periodograms component estimates the power of the GSM transmitter output along a frequency range of interest based on the digitized signal. The averaged modified periodograms comprises a partitioning component that defines a plurality of series of consecutive digital samples. A Fast Fourier Transform component computes a frequency domain representation of each of the plurality of series of consecutive digital samples. An averaging component combines the frequency domain representations computed for each of the plurality of series of consecutive digital samples to estimate a power spectrum for the frequency range of interest.

Another embodiment of the present invention includes a system for testing the performance of a Global System for Mobile Communications (GSM) transmitter. A receiver apparatus conditions an output of the GSM transmitter and converts it to a plurality of digital samples representing a digital signal. A phase trajectory testing component determines a phase trajectory error for the GSM transmitter. The phase trajectory evaluation component includes a phase determination component that determines a phase trajectory for the digital signal. The determined phase trajectory includes a transmitted phase value corresponding to each of the plurality of the digital samples comprising the digital signal. An ideal phase generator determines an ideal phase signal from the determined phase trajectory. A phase evaluation component calculates a phase trajectory error from the determined phase trajectory and the ideal phase signal and determines if the phase trajectory error is within acceptable limits.

### BRIEF DESCRIPTION OF THE DRAWINGS

FIG. 1 illustrates a first example of a GSM signal testing system in accordance with an aspect of the invention.

FIG. 2 illustrates a second example of a GSM signal testing system in accordance with an aspect of the invention.

FIG. 3 illustrates a third example of a GSM signal testing system in accordance with an aspect of the invention.

FIG. 4 illustrates an example of a method for testing the spectral content and phase trajectory of GSM transmitter in accordance with an aspect of the present invention.

FIG. 5 illustrates a computer system that can be employed to implement one or more components and functions of the various systems and methods described herein, such as based on computer executable instructions running on the computer system.

### DETAILED DESCRIPTION

The present invention relates to electronic circuits, and more specifically to a testing system for a transmitter operating as part of the Global System for Mobile Communications (GSM) system. The claimed testing system provides a low cost alternative to the use of a spectrum analyzer for evaluating the compliance of a transmitter with GSM standards, specifically the GSM spectral mask. The use of a spectrum analyzer is avoided by digitizing the transmitted signal and subjecting the signal to an averaged modified periodograms algorithm to estimate the power spectrum of the signal over a frequency range of interest. It will be appreciated that this algorithm can be implemented in software at a relatively low cost, and can be executed at a significant savings of time relative to existing methods. Further, the proposed tester is scalable for multi-site testing, providing further efficiency gains at the production level. In addition, the captured digital samples can be reused to efficiently determine a phase trajectory error for the system. This testing has generally been considered cost prohibitive at the chip-level production stage due to the complexity of the test. The proposed system overcomes these difficulties, at least in part, by avoiding the use of a preamble, a reference signal, or a reference bit stream. In the proposed system, an ideal signal is reconstructed from the transmitted signal and used to calculate the phase error, reducing variance between testers to increase the consistency and reliability of test results.

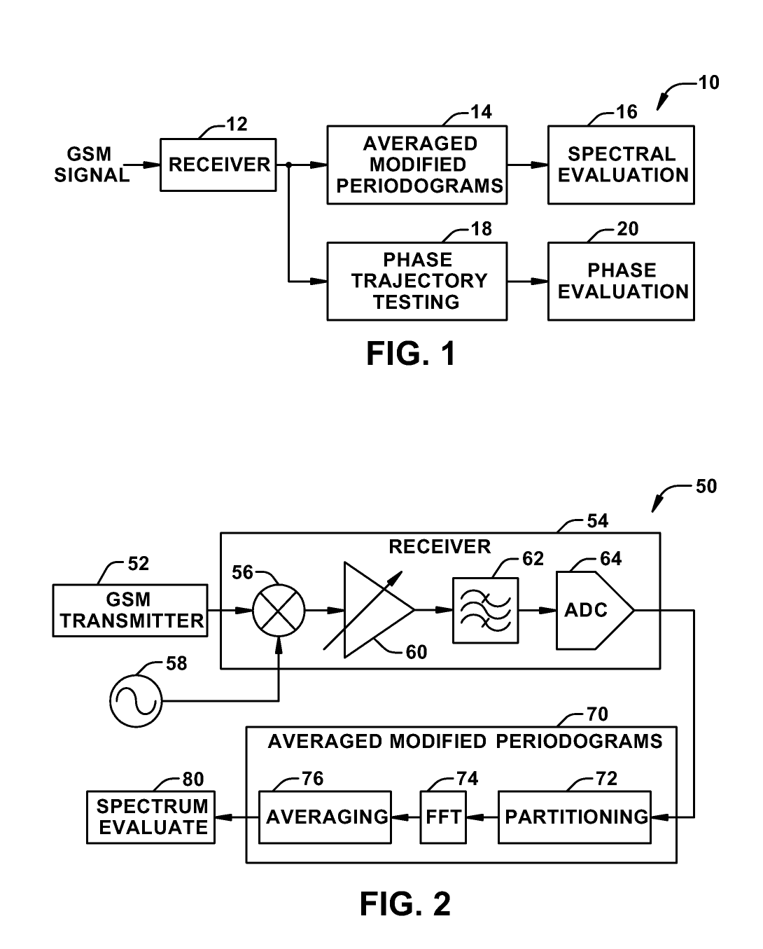

FIG. 1 illustrates an example of a GSM signal testing system 10 in accordance with an aspect of the invention. It will be appreciated that the illustrated system 10 can be implemented as a combination of hardware and software components, such that each of the various elements 12, 14, 16, 18, and 20 can be implemented as dedicated hardware, software, or combination thereof. Accordingly, the various elements 12, 14, 16, 18, and 20 can represent physical hardware components as well as modules within a software program operating on a general purpose computer to perform the described function. The illustrated system 10 includes a receiver apparatus 12 that receives a GSM signal from a GSM transmitter, conditions the received signal to provide a better representation of the signal for analysis, and converts the analog GSM signal into a digital signal. For example, the receiver apparatus 12 can down-convert the GSM signal to an intermediate frequency, filter the signal to a bandwidth of interest, and provide the filtered signal to an analog-to-digital converter to provide the digital signal.

The digital signal is provided to an averaged modified periodograms component 14 that estimates a power spectrum for the GSM signal. The averaged modified periodograms component 14 divides a plurality of digital samples comprising the digital signal into a plurality of series of consecutive samples. It will be appreciated that these series are not exclusive, and that a first series of digital samples can overlap with a second series of samples, such that at least one digital sample is present in both the first series and the second series. Each series is subjected to a Fast Fourier Transform to convert the series of digital samples into a frequency domain representation. These frequency domain representations are then averaged together to estimate a power spectrum for the digital signal. The estimated power spectrum can then be evaluated at a spectral evaluation component 16 to determine if the GSM transmitter complies with the GMSK spectral mask. For example, the signal power at each of a plurality of offset values within the frequency range of interest can be determined relative to the power of a carrier frequency and compared to threshold values.

The digital signal is further provided to a phase trajectory testing component 18. The phase trajectory testing component 18 separates the digital signal into its in band and quadrature components and computes a phase trajectory comprising a transmitted phase value associated with each of the digital samples. The computed transmitted phase values can then be provided to a phase evaluation component 20, where a phase error for the GSM transmitter can be determined. For example, the extracted phase values can then be used to determine an ideal signal, and the transmitted phase trajectory can be aligned with the ideal phase signal to calculate a phase error between the two signals. Specifically, the determined phase can be unwrapped into a continuous phase signal and demodulated to produce the original bit stream. The bit stream can then be changed to a non-return to zero (NRZ) format and passed from a GMSK filter to produce an ideal phase values. The differences between the transmitted phase values and the ideal phase values can be aggregated to determine the degree of phase error in the transmitted GSM signal.

FIG. 2 illustrates a second example of a GSM signal testing system 50 in accordance with an aspect of the invention. The illustrated testing system 50 is designed to provide a high speed, low cost, multi-site testing arrangement for GSM transmitters to ensure compliance with the GMSK spectral mask prescribed by the GSM standard. A GSM transmitter 52 provides a GSM signal to a receiver assembly 54. The GSM signal is down-converted at a mixer 56 using a low cost RF source 58 to an intermediate frequency signal. In one implementation, the original signal can have a frequency on the order of 824.2 MHz, and the intermediate frequency can be around 2.6 MHz. The intermediate frequency signal is amplified at an adjustable gain amplifier 60 and filtered at a bandpass filter 62 to limit the signal to a frequency range of interest. For example, the frequency range of interest can include the intermediate carrier frequency and a 500 kHz band on each side of the carrier frequency. The filtered signal is then provided an analog-to-digital (ADC) converter 64, where the filtered signal is converted into a digital signal comprising a plurality of digital samples. In one implementation, a fourteen-bit ADC was used to provide a relatively high resolution digital signal for analysis.

The digital signal is provided to an averaged modified periodograms component 70 that produces an estimated power spectrum for the GSM signal. A partitioning element 72 partitions the plurality of digital samples into a plurality of series of consecutive samples. It will be appreciated that the series of consecutive samples can overlap, and in fact, allowing for significant overlap between the series can reduce the variance in the estimated power spectrum between tests. In general, for a digital signal comprising N samples, the signal can be divided into K series of length L with an overlap of D, where N, K, and D are non-negative integers, and N and K are greater than one, such that an i^{th} series, xᵢ(n) of the K series can be represented as:

xᵢ(n)=x(n+iD), for n=0, 1, . . . , L−1 Eq. 1

where x(m) represents a m^{th} digital sample.

In one implementation, thirty thousand samples are spanned by fifty-eight series of one-thousand samples, each series overlapping the final five-hundred samples of the previous series. Assuming the K series cover all N samples, it can be shown that N=L+D(K−1). In the illustrated example, a fifty percent overlap is used along with a doubled length sequence, 2L, such that D=L, and the total number of series, K, can be represented as N/L−1.

Each series is provided to a Fast Fourier Transform (FFT) component 74 to convert the series into a frequency domain representation. A number of Fast Fourier Transform algorithms are known, and any appropriate algorithm can be utilized at the FFT component 74 with a corresponding window function, such as the Blackman window or the Hamming window, to provide the frequency domain representation for the plurality of series. In the illustrated example, the signal power, P, for a series, i, at a given increment of bandwidth, ω, can be expressed as:

$${P}_{ω i} ( {e}^{jω} ) = {\sum }_{n = 0}^{L - 1} w ( n ) x ( n + iD ) {e}^{- j n ω} \qquad Eq . 2$$

where w(n) is a window function for the FFT.

These frequency domain representations are averaged together at an averaging component 76 to estimate a power spectrum for the digital signal. The averaging component 76 calculates an average signal strength for each frequency from the plurality of frequency domain representations of the signal. In the illustrated example, an estimated signal power, P, for the signal at a given increment of bandwidth, c, can be determined as:

$${P}_{ω} ( {e}^{jω} ) = \frac{1}{KLU} {\sum }_{i = 0}^{K - 1} {\vert {P}_{ω i} \vert}^{2} = \frac{1}{KLU} {\sum }_{i = 0}^{K - 1} {\vert {\sum }_{n = 0}^{L - 1} w ( n ) x ( n + iD ) {e}^{- j n ω} \vert}^{2} \\ \text{where} \\ U = \frac{1}{L} {\sum }_{n = 0}^{L - 1} {\vert w ( n ) \vert}^{2} . \qquad Eq . 3$$

The measurement resolution bandwidth of the averaged modified periodograms is defined to be the three decibel bandwidth of the data window, such that Res[P_{ω}(e^{iω})]=(Δω)_{3dB}=C·Fs/N, where C is a constant, Fs is the ADC sampling frequency in FIG. 2 and N is the number of samples in the original time series. The 30 kHz bandwidth specified in the GSM specifications can be achieved by setting Fs and N appropriately. The different window provides different sidelobe suppression levels and helps to reduce spectral leakage.

It will be appreciated that the averaged modified periodograms algorithm can be used to provide a significant time savings over a traditional Fast Fourier Transform. The complexity of a radix-2 FFT is on the order of Nlog(N), where N is the number of samples in the original time series. By performing a series of FFTs in place of one large FFT, the N points are reduced to N/K points, providing a significant savings in computational resources. In one implementation, the test time was found to be reduced over forty percent from previous testing methods. In multi-site testing, where multiple devices are tested in parallel, computational efficiency is highly desirable for maintaining a cost effective testing environment. Further, by averaging the overlapping series, the test variance of the power spectra can be reduced, allowing for superior repeatability of the test. The results of one implementation of the illustrated system have been shown empirically to be comparable with results from a spectrum analyzer.

The estimated power spectrum is evaluated at a spectral evaluation component 80 to determine if the GSM transmitter complies with the GMSK spectral mask. The GSM standard has several spectral mask requirements requiring a specified drop in power at various offsets from the carrier frequency. For example, at an offset of 400 kHz, a 60 dB decrease in power density compared to the density around the carrier frequency should be observed. The spectral evaluation component 80 can evaluate the power spectrum with regard to the GMSK spectral mask, and provide the results to a user for review.

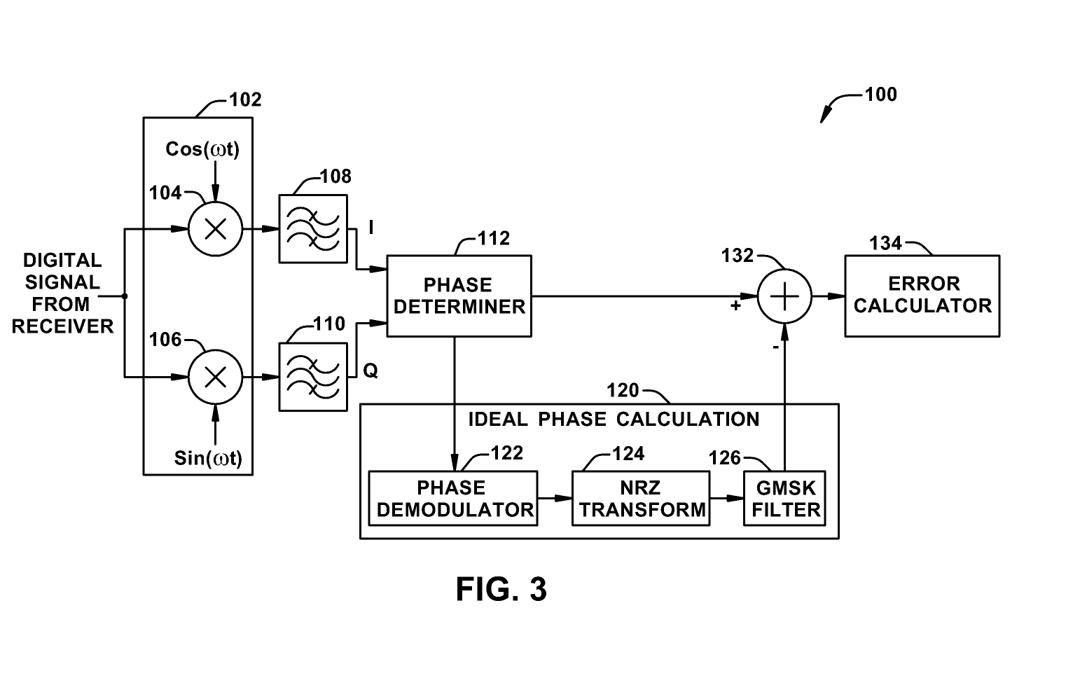

FIG. 3 illustrates a third example of a GSM signal testing system 100 in accordance with an aspect of the invention. The illustrated testing system 100 is designed to provide a high speed, low cost, multi-site testing arrangement for GSM transmitters to determine a phase trajectory error for the signal. In general, poor phase error indicates a problem with one or more of the I/Q baseband generator, the filters, the modulator, or an amplifier in the transmitter circuitry. Signals exhibiting significant phase error are more difficult to demodulate at a receiver, especially under marginal signal conditions, leading to an increased chance of bit error and the corresponding distortion of the recovered data. The allowed phase error for the transmitter has therefore been limited in the GSM specifications to 5 degrees RMS. Additionally, limits have been defined for the peak and for the slope of the phase error. In the past, testing the phase trajectory error during chip-level production tests has been cost prohibitive due to the complexity of the test. In accordance with an aspect of the present invention, the illustrated system provides a low cost solution that can reuse the captured samples from the spectral mask testing system described in FIG. 2. This testing is especially useful in system of a chip (SOC) arrangements, as it allows for the accuracy of the timing components, such as digital phase lock loops, on the chip to be evaluated.

A digital signal, associated with a GSM transmitter, is provided from an associated receiver (e.g., the receiver 54 depicted in FIG. 2) to a signal separation component 102 that divides the digital signal into its in phase (I) and quadrature (Q) components. The signal separation component 102 comprises two digital multipliers 104 and 106 that multiply the signal by cos(ωt) and sin(ωt), where ω is the carrier frequency, to provide, respectively, the in-phase and quadrature components of the signal. Each of the signal components are filtered at respective low pass filters 108 and 110 to remove the intermediate frequency components from the signal. The in phase and quadrature components are then provided to a phase determination component 112 that determines a phase trajectory, comprising a phase value for each of the digital samples, where the phase value is determined as the arctangent of the ratio of the quadrature component to the in-phase component.

In accordance with an aspect of the present invention, the determined phase values are utilized at an ideal phase calculation component 120. The ideal phase calculation component 120 demodulates the phase values into the original bit stream and reconstitutes an ideal continuous phase signal from the original bit stream. Accordingly, it is not necessary to provide the original bit stream or a reference signal to the tester, which avoids the necessity of accounting for phase rotation caused by conventional test boards and testers. Thus, the tester-to-tester test correlation during mass-production can be reduced, allowing for more consistent evaluation of transmitters across multiple testers.

The phase samples are received at a phase demodulator 122 that reconstructs the original bit stream from the determined phase values. Essentially, the phase determination component 112 unwraps the phase to a continuous phase signal, and then the phase demodulator 122 demodulates the signal to reconstruct the original bit stream. The bit stream, \hat{d}, is converted to a non-return to zero (NRZ) format at an NRZ transform 124 such that each NRZ bit, αᵢ, is equal to +1 or −1, such that αᵢ=1−2\hat{d}ᵢ. The NRZ formatted bits are then passed through a Gaussian Minimum Shift Keying (GMSK) filter 126 to produce a continuous phase signal. In the illustrated example, the applied GMSK filter can be expressed as:

$$h ( t ) = \frac{{e}^{\frac{- {T}^{2}}{2 {δ}^{2} {T}^{2}}}}{δ T \sqrt{2 π}} \\ where , \\ δ = \frac{\sqrt{ln ( 2 )}}{2 π BT} , \\ and \\ BT = 0.3 . \qquad Eq . 4$$

From the reconstructed ideal signal and the phase trajectory of the transmitted signal, a phase trajectory error can be determined for the transmitted signal. The reconstructed ideal signal is subtracted from the phase trajectory at an adder 132, and the difference between the signals is provided to an error calculator 134. The error calculator 134 computes an overall phase error in the phase trajectory for the transmitted signal. This phase error can be analyzed to determine if the phase error for the signal remains below a threshold value, and the results can be reported to a user for review.

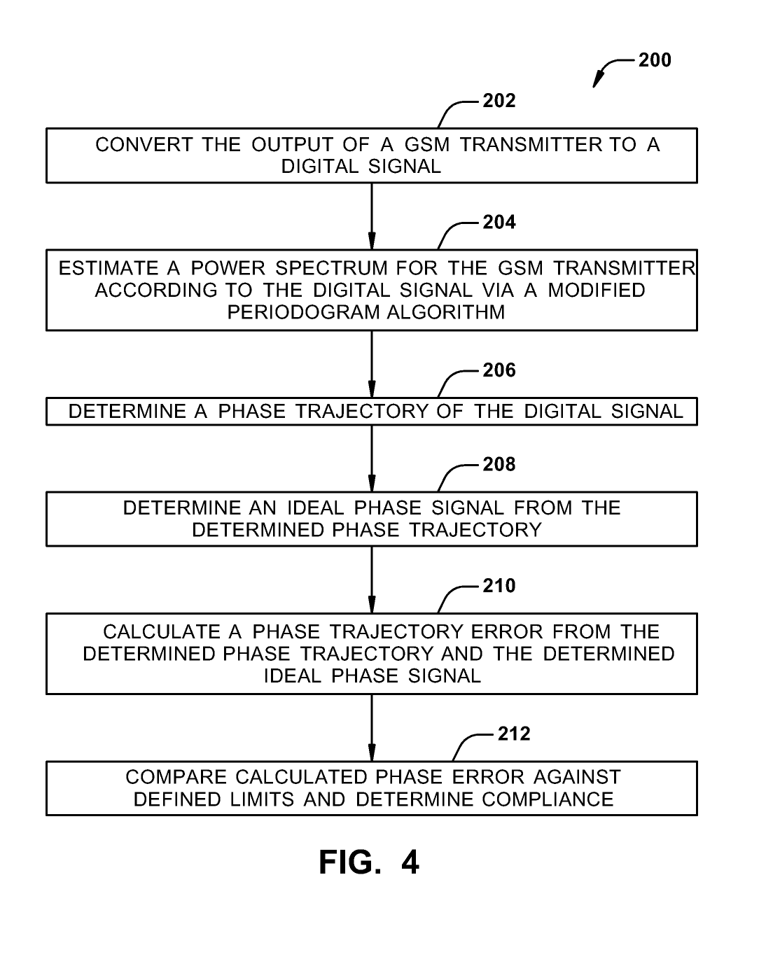

In view of the foregoing structural and functional features described above, certain methods will be better appreciated with reference to FIG. 4. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., analog or digital circuitry, such as may be embodied in an application specific integrated circuit or a computer system), software (e.g., as executable instructions stored on a computer readable media or running on one or more computer systems), or any combination of hardware and software.

FIG. 4 illustrates an example of a method 200 for testing the spectral content and phase trajectory of GSM transmitter in accordance with an aspect of the present invention. At 202, the output of the GSM transmitter is converted to a digital signal. It will be appreciated that the conversion can include some signal conditioning, such that signal components outside of a frequency band of interest are filtered out. In one implementation, the signal is downconverted to an intermediate frequency prior to the analog-to-digital conversion. At 204, a power spectrum is estimated for the GSM transmitter over a frequency range of interest according to the digital signal via an averaged modified periodograms algorithm. In the averaged modified periodograms algorithm, a plurality of series of consecutive digital samples are defined. In one implementation, the plurality of series of consecutive digital samples are selected to include overlap, in order to reduce the test variance. A frequency domain representation is computed for each of the plurality of series of consecutive digital samples, and the frequency domain representations are averaged across the plurality of series to estimate the power spectrum for the frequency range of interest.

At 206, a phase trajectory is determined for the digital signal. For example, the digital signal can be divided into in-phase and quadrature components, with an in-phase value and a quadrature value for each of the plurality of digital samples comprising the digital signal. A phase value for each digital sample can be calculated as the arctangent of a ratio of the quadrature value to the in-phase value to provide the phase trajectory. At 208, an ideal phase signal is determined from the determined phase trajectory. An original bit stream can be reconstructed from the determined phase values and converted to a non-return to zero format. The converted bit stream can be filtered with a Gaussian Minimum Shift Keying filter to produce the ideal phase signal. At 210, a phase trajectory error is calculated from the determined phase trajectory and the determined ideal phase signal. At 212, the calculated phase trajectory error is compared against defined limits to determine compliance of the output with a predetermined standard.

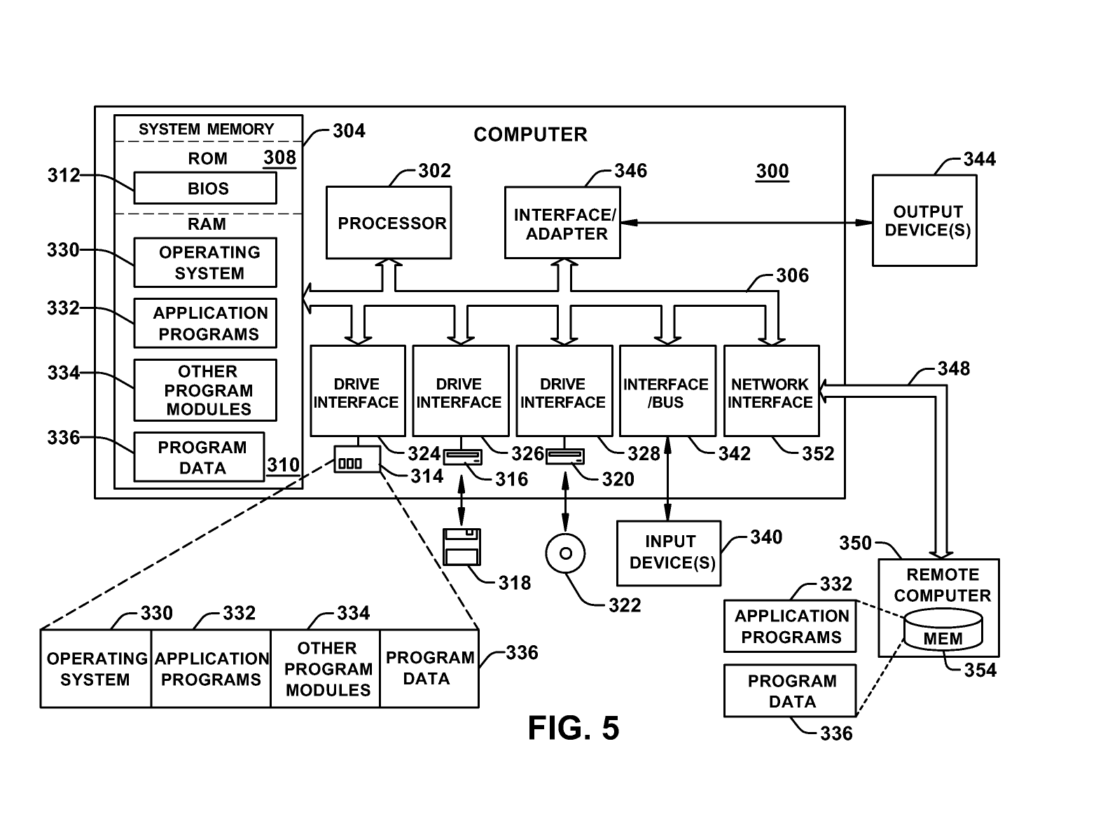

FIG. 5 illustrates a computer system 300 that can be employed to implement one or more components and functions of the various systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. A system bus 306 couples various system components, including a coupling of the system memory 304 to the processor 302. Dual microprocessors and other multi-processor architectures can also be utilized as the processor 302. The system bus 306 can be implemented as any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) 312 can reside in the ROM 308, generally containing the basic routines that help to transfer information between elements within the computer system 300, such as a reset or power-up.

The computer system 300 can include a hard disk drive 314, a magnetic disk drive 316, (e.g., to read from or write to a removable disk 318), and an optical disk drive 320, (e.g., for reading a CD-ROM or DVD disk 322 or to read from or write to other optical media). The hard disk drive 314, magnetic disk drive 316, and optical disk drive 320 are connected to the system bus 306 by a hard disk drive interface 324, a magnetic disk drive interface 326, and an optical drive interface 334, respectively. The drives and their associated computer-readable media provide nonvolatile storage of data, data structures, and computer-executable instructions for the computer system 300. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital versatile disks and the like.

A number of program modules may also be stored in one or more of the drives as well as in the RAM 310, including an operating system 330, one or more application programs 332, other program modules 334, and program data 336.

A user may enter commands and information into the computer system 300 through user input device 340, such as a keyboard or a pointing device (e.g., a mouse). Other input devices may include a microphone, a joystick, a game pad, a scanner, a touch screen, or the like. These and other input devices are often connected to the processor 302 through a corresponding interface or bus 342 that is coupled to the system bus 306. Such input devices can alternatively be connected to the system bus 306 by other interfaces, such as a parallel port, a serial port or a universal serial bus (USB). One or more output device(s) 344, such as a visual display device or printer, can also be connected to the system bus 306 via an interface or adapter 346.

The computer system 300 may operate in a networked environment using logical connections 348 to one or more remote computers 350. The remote computer 348 may be a workstation, a computer system, a router, a peer device or other common network node, and typically includes many or all of the elements described relative to the computer system 300. The logical connections 348 can include a local area network (LAN) and a wide area network (WAN).

When used in a LAN networking environment, the computer system 300 can be connected to a local network through a network interface 352. When used in a WAN networking environment, the computer system 300 can include a modem (not shown), or can be connected to a communications server via a LAN. In a networked environment, application programs 332 and program data 336 depicted relative to the computer system 300, or portions thereof, may be stored in memory 354 of the remote computer 350.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A method for testing the performance of a Global System for Mobile Communications (GSM) transmitter, comprising:
converting the output of the GSM transmitter to a digital signal;
estimating a power spectrum for the GSM transmitter for a frequency range of interest according to the digital signal via an averaged modified periodograms algorithm;
determining a phase trajectory of the digital signal;
determining an ideal phase signal from the determined phase trajectory; and
calculating a phase trajectory error from the determined phase trajectory and the determined ideal phase signal.

2. The method of claim 1, wherein estimating the power spectrum for the GSM transmitter comprises:
defining a plurality of series of consecutive digital samples;
computing a frequency domain representation of each of the plurality of series of consecutive digital samples; and
combining the frequency domain representations computed for each of the plurality of series of consecutive digital samples to estimate the power spectrum for the frequency range of interest.

3. The method of claim 2, wherein defining the plurality of series of consecutive digital samples comprises selecting the plurality of series of consecutive digital samples such that the series of consecutive digital samples overlap.

4. The method of claim 1, wherein determining the ideal phase signal from the determined phase trajectory comprises:
reconstructing an original bit stream from the determined phase values;
converting the bit stream to a non-return to zero format; and
filtering the converted bit stream with a Gaussian filter to produce the ideal phase signal.

5. The method of claim 1, wherein determining the phase trajectory of the digital signal comprises:
dividing the digital signal into in phase and quadrature components, such that an in phase value and a quadrature value are obtained for each of a plurality of digital samples comprising the digital signal; and
calculating the arctangent of a ratio of the quadrature value to the in phase value for each of the plurality of digital samples.

6. The method of claim 1, further comprising determining if the calculated phase trajectory error remains below a defined threshold value.

7. The method of claim 1, further comprising determining from the estimated power spectrum if the GSM transmitter output falls within a defined spectral mask.

8. A system for testing the performance of a Global System for Mobile Communications (GSM) transmitter, comprising:
a receiver apparatus that conditions an output of the GSM transmitter and converts the output to a plurality of digital samples representing a digital signal; and
a modified periodogram component that estimates the power of the GSM transmitter output along a frequency range of interest, comprising:
a partitioning component that defines a plurality of series of consecutive digital samples;
a Fast Fourier Transform component that computes a frequency domain representation of each of the plurality of series of consecutive digital samples; and
an averaging component that combines the frequency domain representations computed for each of the plurality of series of consecutive digital samples to estimate a power spectrum for the frequency range of interest.

9. The system of claim 8, the partitioning component defining the plurality of series of consecutive digital samples such that the series of consecutive digital samples overlap.

10. The system of claim 8, the system comprising a multi-site tester that tests the performance of a plurality of GSM transmitters in parallel.

11. The system of claim 8, further comprising a phase trajectory testing component that determines a phase trajectory error for the GSM transmitter, the phase trajectory evaluation component comprising:
a signal separation component that divides the digital signal into in-phase and quadrature components;
a phase determination component that determines a phase trajectory for the digital signal from the in-phase and quadrature components, the determined phase trajectory comprising a transmitted phase value corresponding to each of a plurality of digital samples comprising the digital signal; and
a phase evaluation component that calculates a phase trajectory error for the digital signal and determines if the phase trajectory error is within acceptable limits.

12. The system of claim 11, further comprising an ideal phase generator that determines an ideal phase signal from the determined phase trajectory, the phase evaluation component being operative to calculate the phase trajectory error from the ideal phase signal and the determined phase trajectory.

13. The system of claim 12, the ideal phase generator comprising:
a phase demodulator that reconstructs an original bit stream from the determined phase values;
a non-return to zero transform that converts the bit stream to a non-return to zero format; and
a Gaussian filter that filters the converted bit stream to produce a the ideal phase signal.

14. The system of claim 8, further comprising a spectral evaluation component that determines from the estimated power spectrum if the GSM transmitter output falls within a defined spectral mask.

15. A system for testing the performance of a Global System for Mobile Communications (GSM) transmitter, comprising:
a receiver apparatus that conditions an output of the GSM transmitter and converts the output to a plurality of digital samples representing a digital signal; and
a phase trajectory testing component that determines a phase trajectory error for the GSM transmitter, the phase trajectory evaluation component comprising:
a phase determination component that determines a phase trajectory for the digital signal, the determined phase trajectory comprising a transmitted phase value corresponding to each of a plurality of digital samples comprising the digital signal;
an ideal phase generator that determines an ideal phase signal from the determined phase trajectory; and
a phase evaluation component that calculates a phase trajectory error from the determined phase trajectory and the ideal phase signal and determines if the phase trajectory error is within acceptable limits.

16. The system of claim 15, further comprising a signal separation component that divides the digital signal into in phase and quadrature components, the phase determination component determining the phase trajectory from the in phase and quadrature components of the digital signal.

17. The system of claim 15, the ideal phase generator comprising:
a phase demodulator that reconstructs an original bit stream from the determined phase values;
a non-return to zero transform that converts the bit stream to a non-return to zero format; and
a Gaussian Minimum Shift Keying filter that filters the converted bit stream to produce the ideal phase signal.

18. The system of claim 15, further comprising an averaged modified periodograms component that estimates the power of the GSM transmitter output along a frequency range of interest, comprising:
a partitioning component that defines a plurality of series of consecutive digital samples;
a Fast Fourier Transform component that computes a frequency domain representation of each of the plurality of series of consecutive digital samples; and
an averaging component that combines the frequency domain representations computed for each of the plurality of series of consecutive digital samples to estimate a power spectrum for the frequency range of interest.

19. The system of claim 18, further comprising a spectral evaluation component that determines from the estimated power spectrum if the GSM transmitter output falls within a defined spectral mask.

20. The system of claim 15, the system comprising a multi-site tester that tests the performance of a plurality of GSM transmitters in parallel.
